(19) United States
(12) Patent Application Publication
(10) Pub. No.: US 2026/0063761 A1
(43) Pub. Date: Mar. 5, 2026

(54) RADAR SYSTEM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Yoshie KOBAYASHI, Nisshin-shi (JP)

(21) Appl. No.: 19/261,338

(22) Filed: Jul. 7, 2025

(30) Foreign Application Priority Data
Aug. 29, 2024 (JP) 2024-147635

(51) Int. Cl. G01S 7/40; G01S 7/4915

(52) U.S. Cl. CPC G01S 7/403; G01S 7/4915

(57) ABSTRACT

A radar system includes: radars arranged in a spatially separated manner and including transmission and reception antennas for a radar signal; a local oscillator for providing a reference signal; and a processor for estimating an azimuth of an object. Each radar includes: an RF circuit for processing a signal in a same frequency band as the radar signal to generate an IF signal; and a BB circuit for processing the IF signal. The processor includes: a delay time calculation unit for calculating delay times of the RF circuit and BB circuit between radars based on a measurement result of the object; a phase error correction unit for correcting a phase of the IF signal based on the delay times; and an azimuth estimation unit for estimating the azimuth of the object based on a corrected IF signal.

### CROSS REFERENCE TO RELATED APPLICATION

The present application claims the benefit of priority from Japanese Patent Application No. 2024-147635 filed on Aug. 29, 2024. The entire disclosure of the above application is incorporated herein by reference.

### TECHNICAL FIELD

The present disclosure relates to a radar system.

### BACKGROUND

In a radar system that estimates the azimuth of an object using transmission and reception signals from multiple radars, it is necessary to synchronize the frequencies and phases of the transmission and reception signals between the radars in order to improve the accuracy of the azimuth estimation. For example, a configuration is known in which a common reference signal generated by a local oscillator is distributed to a plurality of radars, and each radar multiplies the reference signal to generate a transmission signal, thereby achieving frequency and phase synchronization.

However, a difference in delay times occur between radars due to variations in wiring and circuit manufacturing, and the like, and a phase error proportional to the difference in the delay time is generated in the phase of the reflection signal from the object observed by the reception antenna.

For example, a conceivable technique teaches a method of arranging parts of virtual antennas constituting each radar at overlapping positions and correcting a phase error so that the phases of the virtual antennas at the overlapping positions become equal.

### SUMMARY

According to an example, a radar system may include: radars arranged in a spatially separated manner and including transmission and reception antennas for a radar signal; a local oscillator for providing a reference signal; and a processor for estimating an azimuth of an object. Each radar may include: an RF circuit for processing a signal in a same frequency band as the radar signal to generate an IF signal; and a BB circuit for processing the IF signal. The processor may include: a delay time calculation unit for calculating delay times of the RF circuit and BB circuit between radars based on a measurement result of the object; a phase error correction unit for correcting a phase of the IF signal based on the delay times; and an azimuth estimation unit for estimating the azimuth of the object based on a corrected IF signal.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a schematic configuration of a radar system according to a first embodiment;

FIG. 2 is a diagram showing a detailed configuration of the radar system;

FIG. 3 is a diagram showing the amplitudes of a reference signal and a radar signal;

FIG. 4 is a diagram showing the frequency of a radar signal in two measurements;

FIG. 5 is a diagram showing transmission and reception signals in each radar;

FIG. 6 is a diagram showing a beat signal in each radar;

FIG. 7 is a diagram illustrating a correction method of the phase;

FIG. 8 is a diagram showing the relationship between the position of a virtual antenna and a delay time;

FIG. 9 is a diagram showing the relationship between the position of a virtual antenna and a phase;

FIG. 10 is a flowchart showing an azimuth estimation process;

FIG. 11 is a flowchart of a phase acquisition process;

FIG. 12 is a diagram showing a result of the azimuth estimation when the phase is not corrected;

FIG. 13 is a diagram showing a result of the azimuth estimation in a first embodiment of the present disclosure;

FIG. 14 is a diagram for explaining a method of estimating a phase error in a first comparison example;

FIG. 15 is a diagram for explaining a method of estimating a phase error in a second comparison example;

FIG. 16 is a diagram showing the frequency of a radar signal according to a second embodiment;

FIG. 17 is a diagram for explaining a measurement method of an object in the third embodiment; and

FIG. 18 is a diagram illustrating a schematic configuration of a radar system according to a fourth embodiment.

### DETAILED DESCRIPTION

However, in the method described in the conceivable technique, it is necessary to overlap the positions of the parts of the virtual antennas, and therefore, the arrangement of the antennas is restricted and the aperture length is reduced.

In view of the above, an object of the present embodiments is to provide a radar system capable of increasing the aperture length without overlapping the positions of virtual antennas.

In order to achieve the above object, according to one aspect of the present embodiments, a radar system includes: a transmission antenna that transmits a radar signal; a reception antenna that receives the radar signal reflected by an object; a plurality of radars that are arranged in a spatially separated manner; a local oscillator that provides a reference signal for generating the radar signal to the plurality of radars; a processor that estimates an azimuth of the object based on a signal generated by each of the plurality of radars; each of the plurality of radars includes: an RF circuit that processes a signal in a same frequency band as the radar signal to generate an IF signal having a lower frequency than the radar signal; and a BB circuit that processes the IF signal; and the processor includes: a delay time calculation unit that calculates a delay time Δt_{RF} of the RF circuit and a delay time Δt_{BB} of the BB circuit between the plurality of radars based on a measurement result of the object; a phase error correction unit that corrects the phase of the IF signal based on calculated delay times Δt_{RF} and Δt_{BB}; and an azimuth estimation unit that estimates the azimuth of the object based on corrected IF signal.

According to this feature, the delay times of the RF circuit and the BB circuit are calculated based on the measurement results of the object, and the phase of the IF signal is corrected based on the calculated delay time, so there is no need to overlap the positions of the virtual antennas and the aperture length can be increased.

A reference numeral in parentheses attached to each component or the like indicates an example of correspondence between the component or the like and specific component or the like described in embodiments below.

Hereinafter, embodiments of the present disclosure will be described with reference to the drawings. In each embodiment described below, same or equivalent parts are designated with the same reference numerals.

### First Embodiment

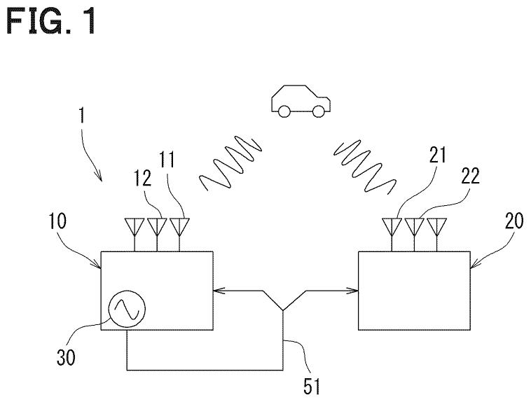

The following describes the first embodiment. A radar system 1 according to the present embodiment shown in FIG. 1 is mounted on, for example, a vehicle and executes azimuth estimation of an object such as other vehicles. The radar system 1 includes a transmission antenna for transmitting a radar signal and a reception antenna for receiving the radar signal reflected by the object, and includes a plurality of radars arranged in a spatially separated manner. In the present embodiment, the case where the radar system 1 includes two radars.

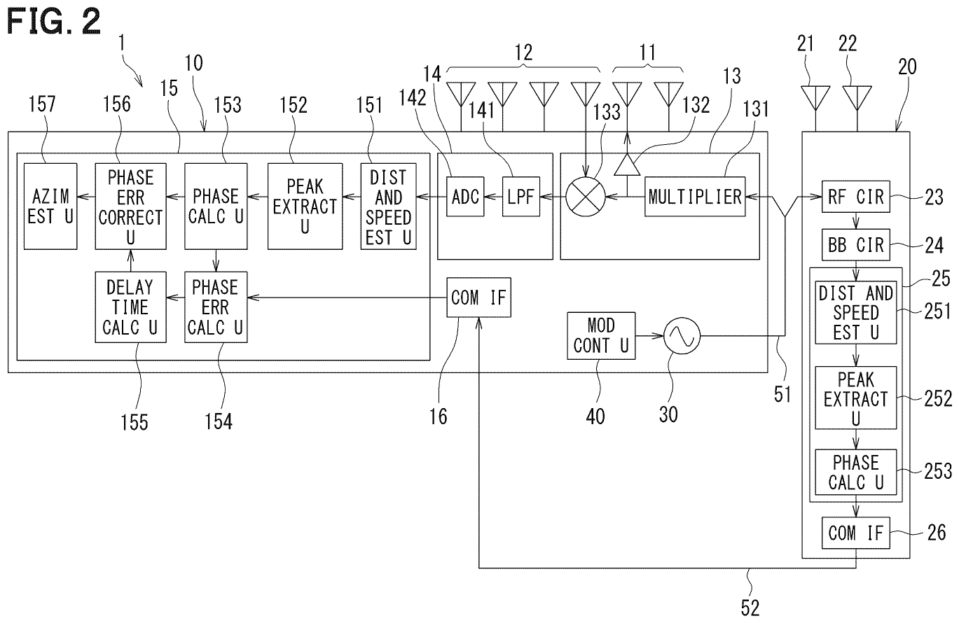

As shown in FIGS. 1 and 2, the radar system 1 includes a radar 10, a radar 20, a local oscillator 30, and a modulation control unit 40. The radar 10 corresponds to a first radar, and the radar 20 corresponds to a second radar. The local oscillator 30 provides a reference signal for generating the radar signal to the first and second radars 10, 20. The modulation control unit 40 controls the modulation of the reference signal generated by the local oscillator 30, and the frequency of the reference signal is set by the signal input from the modulation control unit 40 to the local oscillator 30.

The radar system 1 is configured such that a reference signal generated by a local oscillator 30 is supplied to the radars 10 and 20, and the radar signals generated from this reference signal are transmitted and received by each of the radars 10 and 20.

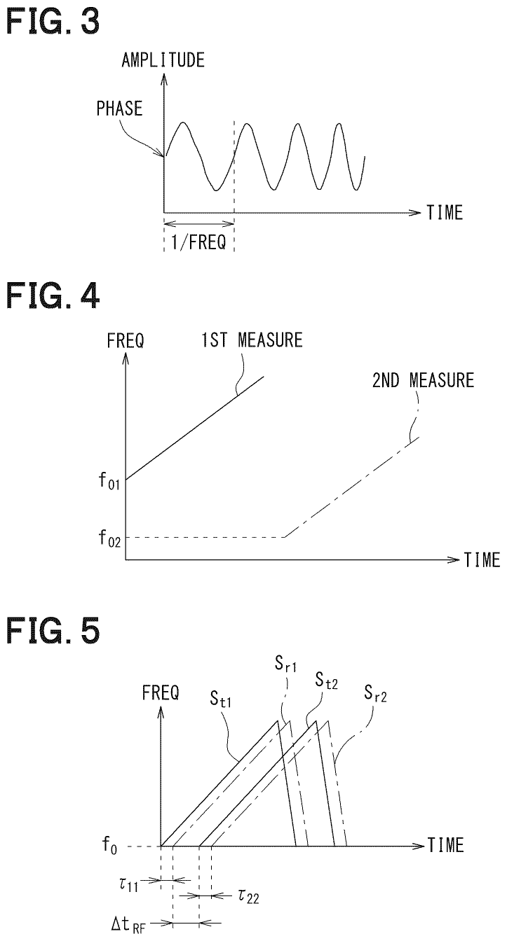

In this embodiment, linear frequency modulation is used as the modulation method for the radar signal. Specifically, the modulation control unit 40 controls the frequency of the reference signal so that the radar signal includes a chirp signal whose frequency changes linearly at a predetermined chirp rate. In this embodiment, the modulation control unit 40 modulates the frequency of the reference signal so that the radar signal and the reference signal include an up-chirp signal as shown in FIG. 3. Alternatively, the frequency of the reference signal may be modulated so that the radar signal and the reference signal include a down-chirp signal. The up-chirp signal is a signal whose frequency increases over time, and the down-chirp signal is a signal whose frequency decreases over time.

As shown in FIG. 2, in this embodiment, the local oscillator 30 and the modulation control unit 40 are arranged inside the radar 10. Alternatively, the local oscillator 30 and the modulation control unit 40 may also be arranged inside the radar 20. The reference signal generated by the local oscillator 30 is input via a wiring 51 to RF circuits 13 and 23, which will be described later.

As shown in FIGS. 1 and 2, the radar 10 includes a plurality of transmission antennas 11 and a plurality of reception antennas 12. The plurality of transmission antennas 11 and the plurality of reception antennas 12 are arranged in a row on a substrate (not shown). In FIG. 1, only a portion of the transmission antennas 11 and the reception antennas 12 is shown.

The radar 10 detects an object using MIMO, which constitutes a virtual antenna by combining a plurality of transmission antennas 11 and a plurality of reception antennas 12. Any method such as TDM, DDM, RDM, FDM, CDM, and the like can be used for modulation to multiplex a plurality of transmission signals. MIMO is an abbreviation for Multiple-Input Multiple-Output. TDM is an abbreviation for Time Division Multiplexing. DDM is an abbreviation for Doppler Division Multiplexing. RDM is an abbreviation for Range Division Multiplexing. FDM is an abbreviation for Frequency Division Multiplexing. CDM is an abbreviation for Code Division Multiplexing.

In the present embodiment, a case where the radar 10 includes two transmission antennas 11 and four reception antennas 12 will be described as an example. As shown in FIG. 2, the radar 10 includes an RF (i.e., Radio Frequency) circuit 13, a BB (i.e., Base Band) circuit 14, a processor 15, and a communication IF (i.e., Interface) 16.

The RF circuit 13 generates a radar signal by processing a reference signal supplied from a local oscillator 30, and also generates an IF (Intermediate Frequency) signal having a lower frequency than the radar signal by processing a signal in the same frequency band as the radar signal. The IF signal is a signal in a frequency band between the signal to be processed by the RF circuit 13 and the signal to be generated by the BB circuit 14.

In this embodiment, as an example, a case will be described in which the reference signal and the radar signal have carrier wave frequencies in the GHz band, specifically in the millimeter wave band, the BB circuit 14 generates a signal in the MHz band, for example, several tens of MHz, and the IF signal is a beat signal generated by multiplying the radar signal. The carrier wave frequency may be preferably 24.05 GHz to 24.25 GHz, or 76 GHz to 81 GHz, or 136 GHz to 148.5 GHZ. Alternatively, the carrier wave frequency may be other frequencies. The RF circuit 13 includes a multiplier 131, a PA (i.e., power amplifier) 132, and a mixer 133. The RF circuit 13 also includes a phase shifter, an LNA (i.e., low noise amplifier), and the like, which are not shown.

The multiplier 131 multiplies the frequency of the reference signal supplied from the local oscillator 30 by an integer and outputs the multiplied signal. The output signal of the multiplier 131 is input to the PA 132 and the mixer 133.

The PA 132 amplifies the signal input from the multiplier 131 to generate a radar signal. The radar signal generated by the PA 132 is transmitted to the outside of the radar system 1 by the transmission antenna 11, reflected by an object, and then received by the reception antenna 12.

The mixer 133 multiplies the signal input from the multiplier 131 by the radar signal received by the reception antenna 12 to generate a beat signal, which is an IF signal. The beat signal generated by the mixer 133 is input to the BB circuit 14.

The BB circuit 14 processes the beat signal input from the RF circuit 13 and generates a signal having a lower frequency than the beat signal. The BB circuit 14 includes an LPF (i.e., low pass filter) 141 and an ADC (i.e., analog-to-digital converter) 142, and the output signal of the mixer 133 is input to the LPF 141. In the beat signal generated by the mixer 133, the high frequency components are removed by the LPF 141 and the low frequency components are extracted, and then, the beat signal is converted into a digital signal by the ADC 142 and input to the processor 15.

The processor 15 estimates the range, speed and azimuth of the object based on the signals generated by the radars 10 and 20. The processor 15 includes a distance and speed estimation unit 151, a peak extraction unit 152, a phase calculation unit 153, a phase error calculation unit 154, a delay time calculation unit 155, a phase error correction unit 156, and an azimuth estimation unit 157, and the output signal of the BB circuit 14 is input to the distance and speed estimation unit 151. The radar 20 may have the same configuration as the phase error calculation unit 154 to the azimuth estimation unit 157 and execute the processes of phase error calculation, delay time calculation, phase error correction, and azimuth estimation, which will be described later.

The distance and speed estimation unit 151 estimates the distance between the radar 10 and an object, and the speed of the object. The distance and speed estimation results acquired by the distance and speed estimation unit 151 are input to the peak extraction unit 152.

The peak extraction unit 152 extracts peaks of the signal input from the distance and speed estimation unit 151. The peak extraction result by the peak extraction unit 152 is input to the phase calculation unit 153.

The phase calculation unit 153 calculates the phase of the peak extracted by the peak extraction unit 152. The phase calculation result by the phase calculation unit 153 is input to a phase error calculation unit 154 and a phase error correction unit 156.

Here, the radar 20 includes a plurality of transmission antennas 21 and a plurality of reception antennas 22, similar to the radar 10. In FIGS. 1 and 2, only a portion of the transmission antennas 21 and the reception antennas 22 is shown. The radar 20 also includes an RF circuit 23 and a BB circuit 24 that have the same configurations as the RF circuit 13 and the BB circuit 14 that the radar 10. The radar 20 also includes a processor 25, which includes a distance and speed estimation unit 251, a peak extraction unit 252, and a phase calculation unit 253 that have similar configurations to the distance and speed estimation unit 151, the peak extraction unit 152, and the phase calculation unit 153. The phase calculation result by the phase calculation unit 253 is input to a phase error calculation unit 154 via the communication IF 26, the wiring 52 and the communication IF 16.

The phase error calculation unit 154 calculates the phase error between the beat signal generated by the BB circuit 14 and the beat signal generated by the BB circuit 24 based on the phase calculation results by the phase calculation units 153 and 253. The calculation result of the phase error by the phase error calculation unit 154 is input to a delay time calculation unit 155.

The delay time calculation unit 155 calculates the delay times of the RF circuits 13 and 23 and the delay times of the BB circuits 14 and 24 based on the object measurement results and the phase error calculated by the phase error calculation unit 154. The measurement result of the object is the result of transmitting and receiving the radar signal to the object, specifically, the frequency of the radar signal and the frequency of the beat signal. Then, the delay time calculation unit 155 calculates the delay time Δt_{RF}, which is the difference between the delay time of the RF circuit 13 and the delay time of the RF circuit 23. Further, the delay time calculation unit 155 calculates the delay time Δt_{BB}, which is the difference between the delay time of the BB circuit 14 and the delay time of the BB circuit 24. The calculation results of the delay times Δt_{RF} and Δt_{BB} by the delay time calculation unit 155 are input to the phase error correction unit 156.

The phase error correction unit 156 corrects the phase error of the beat signal based on the phase calculation result by the phase calculation unit 153 and the calculation results of the delay times Δt_{RF} and Δt_{BB} by the delay time calculation unit 155. The correction result of the phase error by the phase error correction unit 156 is input to an azimuth estimation unit 157.

The azimuth estimation unit 157 estimates the azimuth of the object based on the beat signal whose phase has been corrected by the phase error correction unit 156. When the radar system 1 is mounted on a vehicle, the result of the azimuth estimation by the azimuth estimation unit 157 is transmitted to, for example, an ECU (i.e., Electronic Control Unit, not shown) and is used to execute collision avoidance operations, and the like.

The details of the processing executed by the processor 15 will be described later. First, a method for calculating the phase of a beat signal by the distance and speed estimation unit 151 and the peak extraction unit 152 will be described. The beat signals generated by the BB circuits 14 and 24 are designated as S_{b1} and S_{b2}, respectively.

The distance and speed estimation unit 151 executes frequency analysis on the beat signal S_{b1} input from the BB circuit 14 to acquire a spectrum having frequency components corresponding to the distance and speed of the object, and estimates the distance and speed of the object from this spectrum. As a method of the frequency analysis, for example, FFT (i.e., Fast Fourier Transform), DFT (i.e, Discrete Fourier Transform), and the like can be used. The distance and speed estimation unit 151 transmits the distance and speed estimation results and the acquired spectrum to the peak extraction unit 152.

The peak extraction unit 152 executes a threshold process on the signal input from the distance and speed estimation unit 151 to extract, as peaks, the maximum values of the spectrum corresponding to the distance and speed of the object. As the threshold process, for example, CA-CFAR (i.e., Cell Averaging Constant False Alarm Rate), OS-CFAR (i.e., Order Statistic Constant False Alarm Rate), and the like can be used.

The distance and speed estimation by the distance and speed estimation unit 151 and the extraction of the peaks by the peak extraction unit 152 are executed for each of virtual antennas 171 to 178, which will be described later. Similarly, the processor 25 also executes the distance and speed estimation process and the peak extraction process using the beat signal S_{b2}. The phases of the peaks extracted from the beat signals S_{b1} and S_{b2} are designated as X₁ and X₂, respectively.

Next, a method for calculating the phase error by the phase error calculation unit 154 and a method for calculating the delay time by the delay time calculation unit 155 will be described. The phase error between the beat signals S_{b1} and S_{b2}, that is, the difference between the phase X₁ and the phase X₂, is represented as Y. The phase error Y can be formulated as a linear sum of the phase error caused by the difference in the delay time between the RF circuits 13 and 23 and the difference in the delay time between the BB circuits 14 and 24. That is, the phase error Y is expressed by Expression 1 using the delay times Δt_{RF} and Δt_{BB}.

$$Y = 2 π {f}_{0} Δ {t}_{R F} + 2 π {f}_{b} Δ {t}_{B B} \qquad ( Expression 1 )$$

Here, π is the constant of the circumference of a circle. f₀ is the frequency of the signal passing through the RF circuits 13, 23, i.e., the carrier wave frequency of the radar signal. f_{b} is the frequency of the signal passing through the BB circuits 14, 24, i.e., the frequency of the beat signal.

In Expression 1, there are two unknowns, Δt_{RF} and Δt_{BB}, so if there are two independent expressions, Δt_{RF} and Δt_{BB} can be estimated. For example, the delay times Δt_{RF} and Δt_{BB} can be calculated based on the measurement results of an object using radar signals having a plurality of mutually different carrier wave frequencies f₀.

In this embodiment, as shown in FIG. 4, two of these equations are acquired by measuring an object using radar signals of two different carrier wave frequencies f₀₁ and f₀₂. That is, the radars 10 and 20 transmit and receive radar signals having carrier wave frequencies f₀₁ and f₀₂, and the phase calculation units 153 and 253 calculate the phases of the beat signals S_{b1} and S_{b2}. The chirp rate of the radar signal is set to the same value in two measurements. Therefore, the frequency f_{b} of the beat signal is the same in two measurements.

The phases of the beat signals S_{b1} when the radar 10 transmits and receives the radar signals having carrier wave frequencies f₀₁ and f₀₂ are assumed to be X₁₁ and X₁₂, respectively. The phases of the beat signals S_{b2} when the radar 20 transmits and receives the radar signals having carrier wave frequencies f₀₁ and f₀₂ are assumed to be X₂₁ and X₂₂, respectively.

The phase error calculation unit 154 calculates the expression of “Y₁=X₂₁−X₁₁”, as the phase error Y₁, which is the error between the phases X₁₁ and X₂₁. The phase error calculation unit 154 calculates the expression of “Y₂=X₂₂−X₁₂”, as the phase error Y₂, which is the error between the phases X₁₂ and X₂₂. By executing such two measurements, Expressions 2 and 3 are acquired.

$${Y}_{1} = 2 π {f}_{01} Δ {t}_{R F} + 2 π {f}_{b} Δ {t}_{B B} \qquad ( Expression 2 )$$

$${Y}_{2} = 2 π {f}_{02} Δ {t}_{R F} + 2 π {f}_{b} Δ {t}_{B B} \qquad ( Expression 3 )$$

Then, by subtracting Expression 3 from Expression 2, Expression 4 is acquired, and the delay time Δt_{RF} is calculated as shown in Expression 5. The delay time Δt_{BB} can also be calculated from Expressions 2 and 3. In this manner, the delay time calculation unit 155 calculates the delay times Δt_{RF} and Δt_{BB} based on the phase errors Y₁ and Y₂ and the carrier frequencies f₀₁ and f₀₂.

$${Y}_{1} - {Y}_{2} = 2 π ( {f}_{01} - {f}_{02} ) Δ {t}_{R F} \qquad ( Expression 4 )$$

$${Δt}_{R F} = \frac{{Y}_{1} - {Y}_{2}}{2 π ( {f}_{01} - {f}_{02} )} \qquad ( Expression 5 )$$

In addition, when the radar system 1 is mounted on a vehicle, the delay times Δt_{RF} and Δt_{BB} may be estimated when the vehicle is shipped or while the vehicle is travelling. When the delay times Δt_{RF} and Δt_{BB} are estimated at the time of vehicle shipment, for example, two measurements are executed using a corner reflector as an object. When the delay times Δt_{RF} and Δt_{BB} are estimated while the vehicle is travelling, for example, two measurements are executed using another vehicle or a road side object as an object.

The method of calculating the delay times Δt_{RF} and Δt_{BB} will now be described in detail. The transmission signal and the reception signal of the radar 10 are respectively designated as signals Sₜ₁ and Sᵣ₁, and the transmission signal and the reception signal of the radar 20 are respectively designated as signals Sₜ₂ and Sᵣ₂. The time from the start of transmission of the signal Sₜ₁ by the radar 10 to the start of reception of the signal Sr by the radar 10 is denoted as τ₁₁, and the time from the start of transmission of the signal Sₜ₂ by the radar 20 to the start of reception of the signal Sᵣ₂ by the radar 20 is denoted as τ₂₂.

The signals Sₜ₁, Sᵣ₁, Sₜ₂, and Sᵣ₂ are as shown in FIG. 5. That is, the signal Sᵣ₁ is received after the time τ₁₁ has elapsed since the start of transmission of the signal Sₜ₁, the signal Sₜ₂ is transmitted after the delay time Δt_{RF} has elapsed since the reception of the signal Sr, and the signal Sᵣ₂ is received after the time 122 has elapsed since the start of transmission of the signal Sₜ₂.

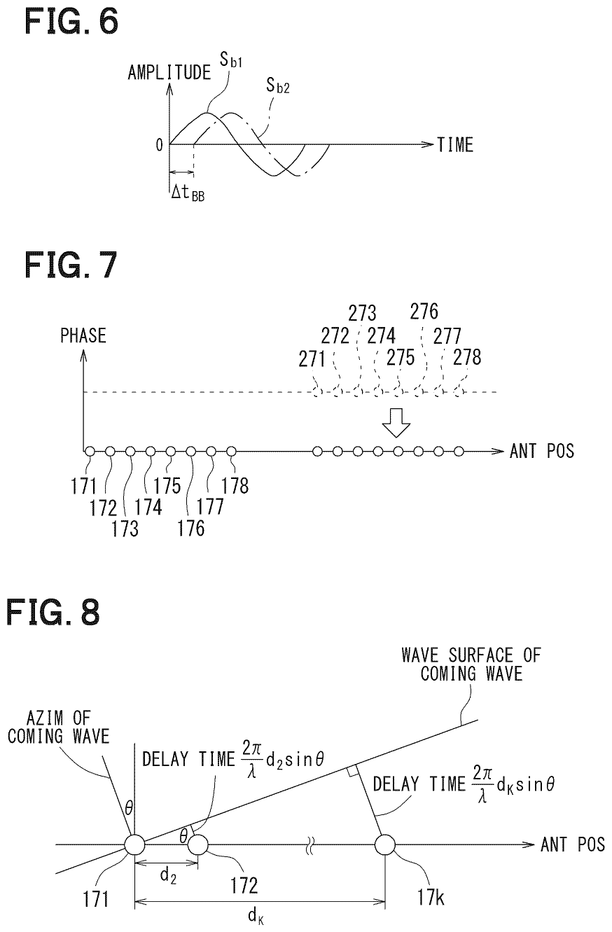

Moreover, the beat signals S_{b1} and S_{b2} are as shown in FIG. 6. That is, the beat signal S_{b2} is delayed by the delay time Δt_{BB} with respect to the beat signal S_{b1}. The time is defined as t, and then, the phases φₗₒ¹(t), φᵣₓ^{1→1}(t), φₗₒ²(t), and φᵣₓ^{2→2}(t) of the signals Sₜ₁, Sᵣ₁, Sₜ₂, and Sᵣ₂ are expressed by Expressions 6 to 9, respectively.

$${φ}_{lo}^{1} ( t ) = 2 π ( {f}_{0} t + \frac{μ {t}^{2}}{2} ) + Φ ( t ) + δ \qquad ( Expression 6 )$$

$${φ}_{rx}^{1 \to 1} ( t ) = {φ}_{lo}^{1} ( t - {τ}_{11} ) \qquad ( Expression 7 )$$

$${φ}_{lo}^{2} ( t ) = 2 π ( {f}_{0} t + \frac{μ {t}^{2}}{2} ) + Φ ( t ) + δ \qquad ( Expression 8 )$$

$${φ}_{rx}^{2 \to 2} ( t ) = {φ}_{lo}^{2} ( t - ( {τ}_{22} + Δ {t}_{RF} ) ) \qquad ( Expression 9 )$$

Here, μ is the chirp rate of the radar signal, and the expression of “μ=df/dt” is satisfied, where f is the frequency of the radar signal. Φ is the phase noise of the radar signal. δ is the initial phase of the radar signal. From Expressions 6 to 9, the phases X₁ and X₂ of the beat signals S_{b1} and S_{b2} are expressed as Expressions 10 and 11.

$$\begin{matrix}{X}_{1} = {φ}_{lo}^{1} ( t ) - {φ}_{rx}^{1 \to 1} ( t ) \\ = 2 π ( μ {τ}_{11} t - \frac{μ {τ}_{11}^{2}}{2} + {f}_{0} {τ}_{11} ) + Φ ( t ) - Φ ( t - {τ}_{11} )\end{matrix} \qquad ( Expression 10 )$$

$$\begin{matrix}{X}_{2} = {φ}_{lo}^{2} ( t ) - {φ}_{rx}^{2 \to 2} ( t ) \\ = 2 π ( μ ( {τ}_{22} + Δ {t}_{RF} ) ( t - \frac{{τ}_{22} + Δ {t}_{RF}}{2} ) + {f}_{0} ( {τ}_{22} + Δ {t}_{RF} ) ) \\ Φ ( t ) - Φ ( t - ( {τ}_{22} + Δ {t}_{RF} ) )\end{matrix} + \qquad ( Expression 11 )$$

Considering the difference in the delay time between the BB circuits 14 and 24, the phase X₂ is expressed by Expression 12, where an expression of “t=t+Δt_{BB}” is satisfied.

$${X}_{2} = 2 \text{} π ( \text{} μ ( {τ}_{22} + Δ {t}_{RF} ) ( t + Δ {t}_{BB} - \frac{{τ}_{22} + Δ {t}_{RF}}{2} ) + {f}_{0} ( {τ}_{22} + Δ {t}_{RF} ) ) + Φ ( t + Δ {t}_{BB} ) - Φ ( t + Δ {t}_{BB} - ( {τ}_{22} + Δ {t}_{RF} ) ) \qquad ( Expression 12 )$$

If an expression of “τ₁₁≈τ₂₂” and an expression of “Φ(t)−Φ(t−τ₁₁)≈Φ(t+Δt_{BB})−Φ(t+Δt_{BB}−(τ₂₂+Δt_{RF}))” are satisfied, then the phase error Y is given by Expression 13.

$$\begin{matrix}Y = {X}_{2} - {X}_{1} \\ = {φ}_{mix}^{2 \to 2} ( t ) - {φ}_{mix}^{1 \to 1} ( t ) \\ = 2 π \{ μ ( {τ}_{22} + Δ {t}_{RF} ) Δ {t}_{BB} - μ \frac{( Δ {t}_{RF} + 2 {τ}_{22} ) Δ {t}_{RF}}{2} + {f}_{0} Δ {t}_{RF} \}\end{matrix} \qquad ( Expression 13 )$$

Here, φₘᵢₓ^{1→1}(t) and φₘᵢₓ^{2→2}(t) are the phases of the beat signals S_{b1} and S_{b2}, and an expression of “X₁=φₘᵢₓ^{1→1}(t)” and an expression of “X₂=φₘᵢₓ^{2→2}(t)” are satisfied. In Expression 13, by changing the carrier wave frequency f₀ to f₀₁ and f₀₂, Expressions 14 and 15 are acquired for the phase errors Y₁ and Y₂.

$${Y}_{1} = 2 π \{ μ ( {τ}_{22} + Δ {t}_{RF} ) Δ {t}_{BB} - μ \frac{( Δ {t}_{RF} + 2 {τ}_{22} ) Δ {t}_{RF}}{2} + {f}_{01} Δ {t}_{RF} \} \qquad ( Expression 14 )$$

$${Y}_{2} = 2 π \{ μ ( {τ}_{22} + Δ {t}_{RF} ) Δ {t}_{BB} - μ \frac{( Δ {t}_{RF} + 2 {τ}_{22} ) Δ {t}_{RF}}{2} + {f}_{02} Δ {t}_{RF} \} \qquad ( Expression 15 )$$

Then, by subtracting Expression 15 from Expression 14, Expression 4 is acquired, and the delay time Δt_{RF} is calculated as shown in Expression 5. Then, using this Δt_{RF}, Δt_{BB} can be acquired from Expression 14 or 15.

The number of virtual antennas formed by the transmission antennas 11 and the reception antennas 12 of the radar 10 is defined as K. In this embodiment, the number of the transmission antennas 11 and the number of the transmission antennas 21 are the same, and the number of the reception antennas 12 and the number of the reception antennas 22 are the same, so the number of virtual antennas formed by the transmission antennas 21 and reception antennas 22 of the radar 20 is also defined as K. In the present embodiment, the K is equal to 8. Here, i is an integer of 1 or more and K or less, Of the multiple virtual antennas configured in the radar 10, the i-th virtual antenna is designated as a virtual antenna 17i. Of the multiple virtual antennas configured in the radar 20, the i-th virtual antenna is designated as a virtual antenna 27i.

The phase error correction unit 156 corrects the phase errors of the radars 10 and 20 based on the phase error Y calculated from the delay times Δt_{RF} and Δt_{BB}. That is, as shown in FIG. 7, the phase X₂ of the beat signal generated from the transmission and reception signals by the virtual antennas 271 to 278 is corrected from the value shown by the dashed line to the value shown by the solid line, as indicated by the white arrow, so that the phases X₁ and X₂ are equal to each other. As a result, the phase X₂ of the beat signal generated from the transmission and reception signals by the virtual antennas 271 to 278 becomes equal to the phase X₁ of the beat signal generated from the transmission and reception signals by the virtual antennas 171 to 178.

The azimuth estimation method will be described as follows. The azimuth estimation unit 157 estimates the azimuth of the object by using a beamforming method. The transmission signal and reception signal of the virtual antenna 17i are multiplied by the mixer 133, and the beat signal processed and acquired by the LPF 141 is denoted as S_{b1,i}. A beat signal acquired by processing the transmission signal and reception signal of the virtual antenna 27i in the RF circuit 23 and the BB circuit 24 in the same manner as in the mixer 133 and the LPF 141 is denoted as S_{b2,i}. The beat signal S_{b1,1} is the difference frequency between the transmission signal and the reception signal of the virtual antenna 171 and is expressed by Expression 16. Here, j is the imaginary unit.

$${S}_{b 11} = exp ( j \cdot {φ}_{mix}^{1 \to 1} ( t ) ) = LPF [ exp ( j \cdot {φ}_{lo}^{1} ( t ) ) \cdot exp ( j \cdot {φ}_{rx}^{1 \to 1} ( t ) ) ] \qquad ( Expression 16 )$$

The phase calculation unit 153 executes a FFT process on the input beat signal. Since the beat signal is a sine wave of the difference frequency, when the FFT process is executed, a peak appears at the difference frequency. The signal generated by processing the beat signal S_{b1,1} in the FFT process is expressed by Expression 17.

$$S ( f ) = F [ exp ( j \cdot {φ}_{mix}^{1 \to 1} ( t ) ) ] \qquad ( Expression 17 )$$

If the phase of the peak, which is the maximum value of this signal, is defined as x₁₁, the phase x₁₁ is expressed by Expression 18.

$${x}_{11} = arg \{ max F [ exp ( j \cdot {φ}_{mix}^{1 \to 1} ( t ) ) ] \} \qquad ( Expression 18 )$$

Similarly, the FFT processing and the extraction of peak phases x₁₂ to x_{1K} are executed on the beat signals S_{b1,2} to S_{b1,k} to acquire a vector of the phase X₁ as shown in Expression 19.

$${X}_{1} = {[ {x}_{11} , {x}_{12} , … , {x}_{1 K} ]}^{T} \qquad ( Expression 19 )$$

In Expression 19, and Expressions 20 and 22 described below, “T” is a transpose. Similarly, in the radar 20, a vector with phase X₂ is acquired.

$${X}_{2} = {[ {x}_{21} , {x}_{22} , … , {x}_{2 K} ]}^{T} \qquad ( Expression 20 )$$

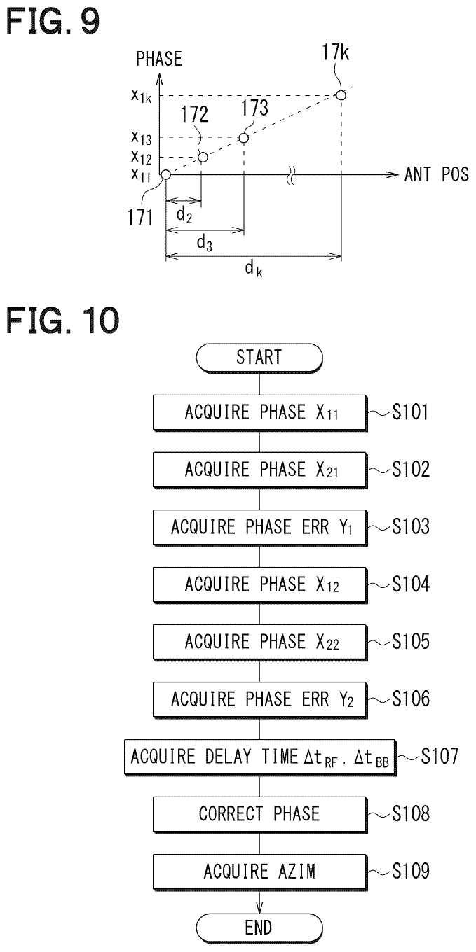

When an incoming wave from an object is received by the virtual antennas 171 to 17K, the delay time of the beat signal is proportional to the antenna position, and the phase of the beat signal is proportional to the delay time. That is, the phase is proportional to the antenna position. Specifically, as shown in FIG. 8, the azimuth of the object is defined as θ, and the distance between the virtual antenna 171 and the virtual antenna 17i is defined as dᵢ. Here, an expression of “d₁=0” is satisfied. Since the distance between the wave front of the incoming wave when the reflection signal from the object reaches the virtual antenna 171 and the virtual antenna 17i is defined as “dᵢ sin θ”, the delay time of the reception signal of the virtual antenna 17i relative to the reception signal of the virtual antenna 171 is defined as “(2π/λ) dᵢ sin θ. Since the phase X₁ᵢ is proportional to the delay time of “(2π/π) dᵢ sin θ”, the phase x₁ᵢ is proportional to the distance dᵢ, as shown in FIG. 9. From these features, the steering vector of the azimuth θ, that is, the reference signal a(θ) for correlating with the phase of the beat signal, is given by Expression 21.

$$a ( θ ) = [ exp ( - j \frac{2 π}{λ} {d}_{1} sin θ ) , exp ( - j \frac{2 π}{λ} {d}_{2} sin θ ) , … , exp ( - j \frac{2 π}{λ} {d}_{K} sin θ ) ] \qquad ( Expression 21 )$$

The phases X₁ and X₂ of the radars 10 and 20 are combined to acquire the phase X of the entire radar system 1.

$$X = {[ {x}_{11} , {x}_{12} , … , {x}_{1 K} , 0 , … , 0 , {x}_{21} , {x}_{22} , … , {x}_{2 K} ]}^{T} \qquad ( Expression 22 )$$

By correlating the phase X with the steering vector a(θ), the azimuth spectrum P_{BF}(θ) is acquired.

$${P}_{BF} ( θ ) = \frac{{a}^{H} ( θ ) {XX}^{H} a ( θ )}{{a}^{H} ( θ ) a ( θ )} \qquad ( Expression 23 )$$

In Expression 23, “H” is the Hermitian transpose. In the azimuth θ having a high correlation with the phase X, the azimuth spectrum P_{BF}(θ) has a large intensity. The azimuth estimation unit 157 estimates this azimuth θ as the azimuth of the object.

The flow of the azimuth estimation process for the object will be described. In the azimuth estimation process, the radar system 1 sequentially executes steps S101 to S109 shown in FIG. 10. The execution order of steps S101 to S106 is not particularly limited as long as there is no technical contradiction. For example, the step S101 may be executed simultaneously with the step S102 or after the step S102. For example, the step S104 may be executed simultaneously with the step S105 or after the step S105. For example, the steps S101 to S103 may be executed simultaneously with the steps S104 to S106 or after the steps S104 to S106.

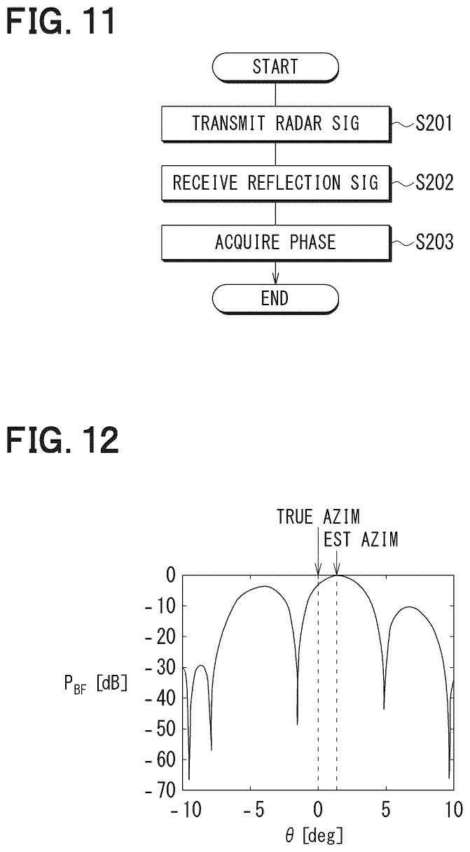

In step S101, the radar system 1 acquires the phase X₁₁. Specifically, the radar system 1 sequentially executes steps S201 to S203 shown in FIG. 11.

In step S201, the radar 10 processes the reference signal generated by the local oscillator 30 using the multiplier 131 and the PA 132 to generate a radar signal with a carrier wave frequency f₀₁, and transmits this radar signal from the transmission antenna 11.

In step S202, the radar 10 receives the radar signal reflected by the object with the reception antenna 12, and processes the received radar signal with an LNA (not shown) or the like.

In step S203, the radar 10 multiplies the transmission signal and the reception signal by the mixer 133, and processes the signal thus generated by the LPF 141 to generate a beat signal S_{b1}. The radar 10 then converts the beat signal S_{b1} into a digital signal by the ADC 142, processes it by the distance and speed estimation unit 151 and the peak extraction unit 152, and then calculates the phase X₁₁ by the phase calculation unit 153.

In step S102, the radar system 1 acquires the phase X₂₁. Specifically, the radar system 1 sets the carrier wave frequency in the radar 20 to be f₀₁ and executes the same process as in step S101. That is, the radar 20 transmits and receives a radar signal having a carrier wave frequency f₀₁, generates a beat signal S_{b2} from the transmission signal and the reception signal, and calculates a phase X₂₁.

In step S103, the radar system 1 acquires the phase error Y₁. Specifically, the phase error calculation unit 154 calculates an expression of “Y₁=X₂₁−X₁₁” based on the phase X₁₁ calculated in step S101 and the phase X₂₁ calculated in step S102.

In step S104, the radar system 1 acquires the phase X₁₂. Specifically, the radar system 1 sets the carrier wave frequency in the radar 10 to be f₀₂ and executes the same process as in step S101. That is, the radar 10 transmits and receives a radar signal having a carrier wave frequency f₀₂, generates a beat signal S_{b1} from the transmission signal and the reception signal, and calculates a phase X₁₂.

In step S105, the radar system 1 acquires the phase X₂₂. Specifically, the radar system 1 sets the carrier wave frequency in the radar 20 to be f₀₂ and executes the same process as in step S101. That is, the radar 20 transmits and receives a radar signal having a carrier wave frequency f₀₂, generates a beat signal S_{b2} from the transmission signal and the reception signal, and calculates a phase X₂₂.

In step S106, the radar system 1 acquires the phase error Y₂. Specifically, the phase error calculation unit 154 calculates an expression of “Y₂=X₂₂−X₁₂” based on the phase X₁₂ calculated in step S104 and the phase X₂₂ calculated in step S105.

In step S107, the radar system 1 acquires the delay times Δt_{RF} and Δt_{BB}. Specifically, the delay time calculation unit 155 calculates the delay times Δt_{RF} and Δt_{BB} using the above-described method based on the phase errors Y₁ and Y₂ acquired in steps S103 and S106.

In step S108, the radar system 1 corrects the phase error between the radar 10 and the radar 20. Specifically, the phase error correction unit 156 calculates the phase error Y based on the delay times Δt_{RF} and Δt_{BB} acquired in step S107, and corrects the phases of the beat signals S_{b1} and S_{b2} based on this phase error Y by the method described above.

In step S109, the radar system 1 acquires the azimuth of the object. Specifically, the azimuth estimation unit 157 estimates the azimuth of the object by the above-described method based on the beat signals S_{b1} and S_{b2} whose phases have been corrected in step S108.

The effects of this embodiment will be described. In the radar system 1, a difference in length between the portion of the wiring 51 that connects the local oscillator 30 and the radar 10 and the portion that connects the local oscillator 30 and the radar 20 causes a difference in the delay time, resulting in a phase error between the beat signals S_{b1} and S_{b2}. Furthermore, due to the difference in the delay time between the RF circuit 13 and the RF circuit 23 and the difference in the delay time between the BB circuit 14 and the BB circuit 24, a phase error occurs between the beat signals S_{b1} and S_{b2}. The phase error increases in proportion to the total delay time.

If the phase error is not corrected, the difference between the true azimuth of the object and the azimuth θ at which the azimuth spectrum P_{BF}(θ) peaks will become large as shown in FIG. 12, due to the difference in length of the wiring 51 and the difference in the delay time of the RF circuits 13, 23 and the BB circuits 14, 24, so that the azimuth estimation error will become large.

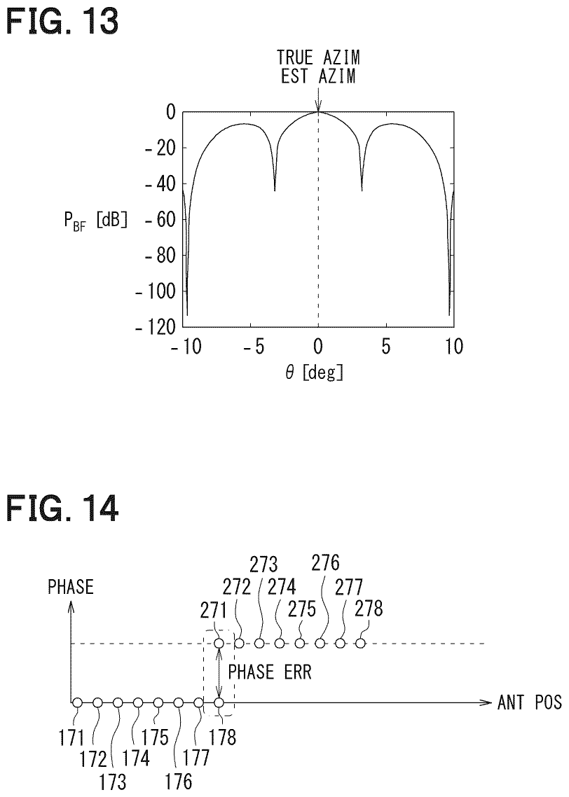

In contrast, by correcting the phase error as in the present embodiment, as shown in FIG. 13, it is possible to reduce the difference between the true azimuth of the object and the azimuth θ at which the azimuth spectrum P_{BF}(θ) has a peak, thereby reducing the azimuth estimation error.

Also, for example, as shown in FIG. 14, a method can be considered in which parts of the virtual antennas 171 to 178 are configured to overlap parts of the virtual antennas 271 to 278, and the phase error is estimated so that the phases of the overlapping virtual antennas become equal to each other. FIG. 14 illustrates the area surrounded by the dashed line, that is, the case where the positions of the virtual antennas 178 and 271 overlap. In this case, the phase difference between the beat signals S_{b18}, S_{b21} is subtracted from the phases of the beat signals S_{b21} to S_{b28} so that the phases of the beat signals S_{b18}, S_{b21} generated from the transmission and reception signals of the virtual antennas 178, 271 become equal to each other. However, this method imposes restrictions on the arrangement of the virtual antennas 171 to 178 and 271 to 278, so that the degree of freedom in design is reduced. Furthermore, the aperture lengths of the virtual antennas 171 to 178 and 271 to 278 become smaller.

In contrast, in this embodiment, there is no need to overlap the positions of the virtual antennas 171 to 178 and 271 to 278, so that the degree of freedom in design is improved and the aperture length of the virtual antennas 171 to 178 and 271 to 278 can be increased.

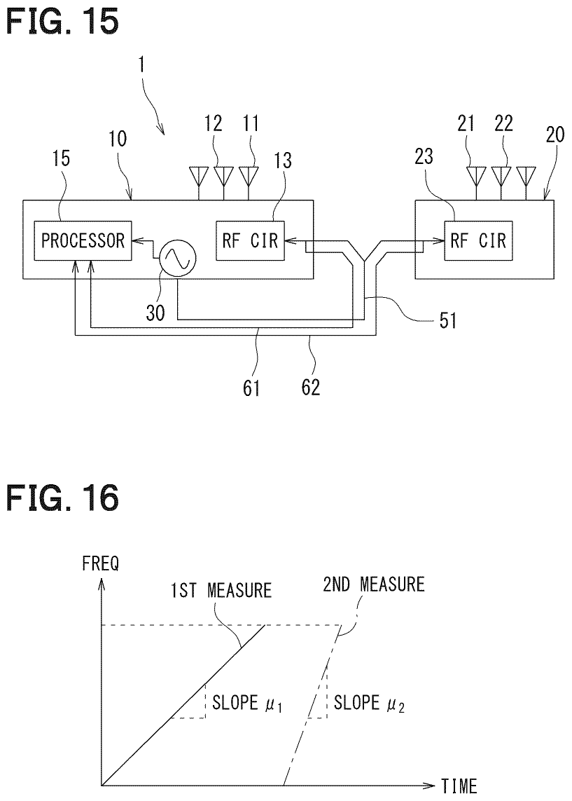

Also, for example, a method can be considered in which a reference signal is transmitted from the radars 10 and 20 to the processor 15 as a return signal, and the processor 15 estimates the phase error based on the difference between the reference signal and the return signal. Specifically, as shown in FIG. 15, the wirings 61 and 62 having the same length are formed so that the reference signals are transmitted from the radars 10 and 20 to the processor 15 as return signals. A reference signal is also transmitted from the local oscillator 30 to the RF circuits 13 and 23 as well as to the processor 15. The processor 15 then mixes the reference signal and the return signal, and estimates the phase error based on the difference signal acquired thereby.

However, while this method can estimate the phase error due to the difference in wiring length, this method cannot estimate the phase error due to the difference in the delay times of the RF circuits 13, 23 and the BB circuits 14, 24 because the reference signal before passing through the RF circuits 13, 23 is used as the return signal. Furthermore, since the wirings 61, 62 are required to transmit the return signal and the reference signal to the processor 15, the manufacturing cost of the radar system 1 increases.

In contrast, in this embodiment, since it is possible to estimate the phase error due to the difference in the delay times of the RF circuits 13 and 23 and the BB circuits 14 and 24, the accuracy of azimuth estimation is improved compared to the comparative example shown in FIG. 15. Furthermore, since the wiring 61 and 62 are not required, an increase in the manufacturing cost of the radar system 1 can be suppressed.

As described above, in this embodiment, the delay time Δt_{RF}, which is the difference between the delay times of the RF circuits 13, 23, and the delay time Δt_{BB}, which is the difference between the delay times of the BB circuits 14, 24, are calculated based on the measurement results of the object. Then, the phase of the beat signal S_{b1}, S_{b2}, which is the IF signal, is corrected based on calculated delay times Δt_{RF} and Δt_{BB}. Therefore, there is no need to overlap the positions of the virtual antennas 171 to 178 and 271 to 278, and the aperture length can be increased.

### Second Embodiment

The following describes the second embodiment of the present disclosure. Since the present embodiment is similar to the first embodiment except that the calculation method of the delay times Δt_{RF} and Δt_{BB} is changed as compared with the first embodiment, only portions different from the first embodiment will be described.

In this embodiment, two expressions for the phase error Y are acquired by measuring an object using the radar signals having two different beat frequencies f_{b}. Specifically, as shown in FIG. 16, a radar signal with a chirp rate μ₁ is transmitted in the first measurement, and a radar signal with a chirp rate μ₂ is transmitted in the second measurement. Since the beat frequency fb is proportional to the chirp rate u, by varying the chirp rate u in this manner, two mutually different beat frequencies can be acquired. The beat frequencies corresponding to the radar signals with the chirp rates μ₁ and μ₂ are denoted as f_{b1} and f_{b2}, respectively. In addition, the frequency at the start and end of the radar signal sweep is set to the same value in the two measurements. Therefore, the frequency f₀ of the carrier wave is the same in two measurements.

In the present embodiment, the phases of the beat signals when the radar 10 transmits and receives the radar signals having chirp rate μ₁ and μ₂ are defined as X₁₁ and X₁₂, respectively. In the present embodiment, the phases of the beat signals when the radar 20 transmits and receives the radar signals having chirp rate μ₁ and μ₂ are defined as X₂₁ and X₂₂, respectively.

The phase error calculation unit 154 calculates the expression of “Y₁=X₂₁−X₁₁”, as the phase error Y₁, which is the error between the phases X₁₁ and X₂₁. The phase error calculation unit 154 calculates the expression of “Y₂=X₂₂−X₁₂”, as the phase error Y₂, which is the error between the phases X₁₂ and X₂₂. By executing such two measurements, Expressions 24 and 25 are acquired.

$${Y}_{1} = 2 π {f}_{0} Δ {t}_{RF} + 2 π {f}_{b 1} Δ {t}_{BB} \qquad ( Expression 24 )$$

$${Y}_{2} = 2 π {f}_{0} Δ {t}_{RF} + 2 π {f}_{b 2} Δ {t}_{BB} \qquad ( Expression 25 )$$

Then, by subtracting Expression 25 from Expression 24, Expression 26 is acquired, and the delay time Δt_{BB} is calculated as shown in Expression 27. The delay time Δt_{RF} can also be calculated from Expressions 24 and 25. In this manner, the delay time calculation unit 155 calculates the delay times Δt_{RF} and Δt_{BB} based on the phase errors Y₁ and Y₂ and the chirp rates μ₁ and μ₂.

$${Y}_{1} - {Y}_{2} = 2 π ( {f}_{b 1} - {f}_{b 2} ) Δ {t}_{BB} \qquad ( Expression 26 )$$

$$Δ {t}_{BB} = \frac{{Y}_{1} - {Y}_{2}}{2 π ( {f}_{b 1} - {f}_{b 2} )} \qquad ( Expression 27 )$$

In the present embodiment, it is possible to attain the advantageous effects as similar to the effects in the first embodiment with the configuration and operation identical to the ones in the first embodiment.

### Third Embodiment

A third embodiment will be described. Since the present embodiment is similar to the second embodiment except that the method for acquiring the beat frequencies f_{b1} and f_{b2} is changed as compared with the second embodiment, only portions different from the second embodiment will be described.

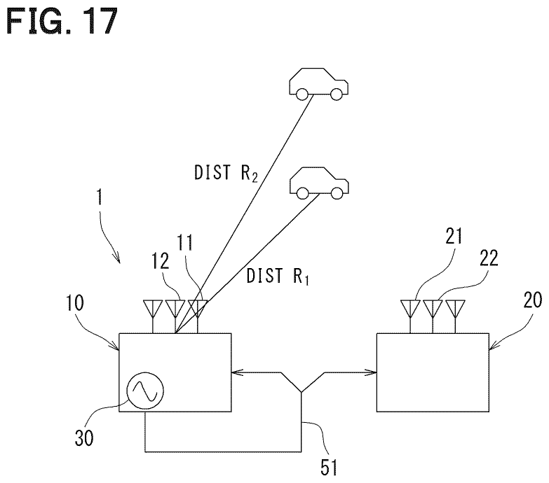

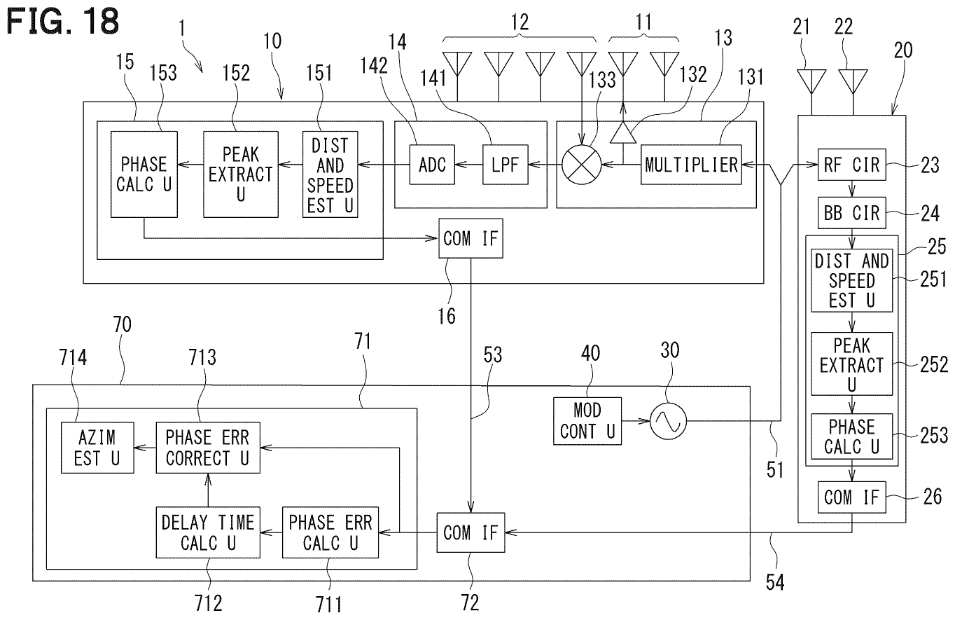

In this embodiment, as shown in FIG. 17, in the first measurement, the radar system 1 transmits a radar signal to an object at a distance R₁, and in the second measurement, the radar system 1 transmits a radar signal to an object at a distance R₂. Since the beat frequency f_{b} is proportional to the distance to the object, by measuring the object at two different distances in this manner, wo mutually different beat frequencies can be acquired.

In the present embodiment, the phases of the beat signals when the radar 10 transmits and receives the radar signals toward the object at two distances R₁ and R₂ are defined as X₁₁ and X₁₂, respectively. Further, the phases of the beat signals when the radar 20 transmits and receives the radar signals toward the object at two distances R₁ and R₂ are defined as X₂₁ and X₂₂, respectively. The beat frequencies corresponding to the distances R₁ and R₂ are denoted as f_{b1} and f_{b2}, respectively.

In the present embodiment, it is possible to attain the advantageous effects as similar to the effects in the first and second embodiments with the configuration and operation identical to the ones in the first and second embodiments.

### Fourth Embodiment

The following describes a fourth embodiment of the present disclosure. Since the present embodiment is similar to the first embodiment except that the positions of the arrangement of the local oscillator 30, the modulation control unit 40 and a part of the processor are changed as compared with the first embodiment, only portions different from the first embodiment will be described.

In this embodiment, the local oscillator 30 and the modulation control unit 40 are disposed in a radar bridge 70 connected to the radars 10 and 20. The radar bridge 70 also includes a processor 71 and a communication IF 72. The processor 71 includes a phase error calculation unit 711, a delay time calculation unit 712, a phase error correction unit 713, and an azimuth estimation unit 714. The processor 15 does not include the phase error calculation unit 154 to the azimuth estimation unit 157, and the phase error calculation unit 711 to the azimuth estimation unit 714 have the same configuration as the phase error calculation unit 154 to the azimuth estimation unit 157 in the first embodiment.

The phase calculation result by the phase calculation unit 153 is input to a phase error calculation unit 711 and the phase error correction unit 713 via the communication IF 16, the wiring 53 and the communication IF 72. The phase calculation result by the phase calculation unit 253 is input to a phase error calculation unit 711 and the phase error correction unit 713 via the communication IF 26, the wiring 54 and the communication IF 72.

Based on the transmitted phase calculation result, the radar bridge 70 executes processes of phase error calculation, delay time calculation, phase error correction, and azimuth estimation in the same manner as the radar 10 of the first embodiment.

In the present embodiment, it is possible to attain the advantageous effects as similar to the effects in the first embodiment with the configuration and operation identical to the ones in the first embodiment.

According to the embodiment described above, it is possible to achieve the following advantageous effects.

The local oscillator 30 and the phase error calculation unit 711 to the azimuth estimation unit 714 are disposed in the radar bridge 70. This allows the processor configuration, which has high manufacturing costs, to be concentrated in the radar bridge 70, and also allows the radars 10 and 20 to have the same configuration, thereby reducing the manufacturing cost of the radar system 1.

### Other Embodiments

The present disclosure is not limited to the above-described embodiments, and can be appropriately modified. The above embodiments are not independent of each other, and can be appropriately combined together except when the combination is obviously impossible. Individual elements or features of a particular embodiment are not necessarily essential unless it is specifically stated that the elements or the features are essential in the foregoing description, or unless the elements or the features are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number.

For example, in the second and third embodiments, the radar system 1 may include a radar bridge 70 as in the fourth embodiment, and the local oscillator 30 and the phase error calculation unit 711 to the azimuth estimation unit 714 may be arranged on the radar bridge 70.

Furthermore, in the first to fourth embodiments, linear frequency modulation is used as the modulation method for the radar signal, but other modulation methods may be used. For example, an Orthogonal Frequency Division Multiplexing (i.e., OFDM) system, a Phase Modulated Continuous Wave (i.e., PMCW) system, and the like may be used.

In the present disclosure or the claims, the term “processor” may refer to a single hardware processor or several hardware processors that are configured to execute processing defined by computer program code (i.e., one or more instructions of a computer program) by sequentially reading the computer program code included in a computer program. In other words, a “processor” is a hardware device that executes one or more program processes. Therefore, the computer program code can be considered software that defines the processing of the processor according to its content. The “processor” may be a general-purpose or specific-purpose processor, such as, CPU (Central Processing Unit), a microprocessor, GPU (Graphics Processing Unit) and DFP (Data Flow Processor), but is not limited to these examples.

In the present disclosure or the claims, the term “memory” is a non-transitory tangible storage medium and may refer to a single or several hardware memories configured to store computer program code and/or data in a manner accessible by the processor. The “memory” may be implemented using any suitable memory technology, such as SRAM (Static Random-access Memory), SDRAM (Synchronous Dynamic RAM), nonvolatile/flash memory, or other types of memory. The computer program code that constitutes the program is stored on the memory and, when executed by a processor, causes the processor to realize the various functions described above.

In the present disclosure or the claims, the term “circuit” refers to a single hardware logic circuit or several hardware logic circuits (in other words, “circuitry”) that are configured to execute specific processing defined based on a pre-designed circuit configuration. In other words (and in contrast to the “processor”), the term “circuit” in the present disclosure or the claims refers to a hardware device that executes specific processing based on a circuit configuration, not processing defined by software such as the above-described computer program code. For instance, “circuit” may include a custom IC (Integrated Circuit) such as ASIC (Application Specific Integrated Circuit) or FPGA (Field Programmable Gate Array) designed using a hardware description language (HDL). That is, the term “circuit” in the present disclosure or the claims includes all hardware circuits except the above-described processor that executes processing by reading computer program code.

In the present disclosure or the claims, the phrase “at least one of a circuit and a processor” should be interpreted disjunctively (logical OR) and should not be interpreted as at least one circuit and at least one processor. Therefore, in the present disclosure or the claim, “at least one of a circuit and a processor is configured to cause a radar system to execute functions” includes the case where only the circuit causes a radar system to execute all the functions. Additionally, “at least one of a circuit and a processor is configured to cause a radar system to execute functions” includes the case where only the processor causes a radar system to execute all the functions. Furthermore, “at least one of a circuit and a processor is configured to cause a radar system to execute functions” includes the case where the circuit causes a radar system to execute some of the functions and the processor causes a radar system to execute the remaining functions. In the last case, for instance, if a radar system executes functions A to C, functions A and B may be implemented by the circuit, and the remaining function C may be implemented by the processor.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A radar system comprising:
a plurality of radars that are arranged in a spatially separated manner and include a transmission antenna for transmitting a radar signal and a reception antenna for receiving the radar signal reflected by an object;
a local oscillator that provides a reference signal for generating the radar signal to the plurality of radars; and
a processor that estimates an azimuth of the object based on a plurality of signals generated by the plurality of radars, wherein:
each of the plurality of radars includes:
an RF circuit that processes a signal in a same frequency band as the radar signal to generate an IF signal having a lower frequency than the radar signal; and
a BB circuit that processes the IF signal; and
the processor includes:
a delay time calculation unit that calculates a delay time of the RF circuit and a delay time of the BB circuit between the plurality of radars based on a measurement result of the object;
a phase error correction unit that corrects a phase of the IF signal based on calculated delay times; and
an azimuth estimation unit that estimates the azimuth of the object based on a corrected IF signal.

2. The radar system according to claim 1, wherein:
the delay time calculation unit calculates the delay times based on measurement results of the object using the radar signal having a plurality of mutually different carrier wave frequencies.

3. The radar system according to claim 2, wherein:
the plurality of radars include a first radar and a second radar;
the plurality of mutually different carrier wave frequencies includes two different carrier wave frequencies defined as f₀₁ and f₀₂;
the phase of the IF signal when the first radar transmits and receives the radar signal having the carrier wave frequency of f₀₁ is defined as X₁₁;
the phase of the IF signal when the first radar transmits and receives the radar signal having the carrier wave frequency of f₀₂ is defined as X₁₂;
the phase of the IF signal when the second radar transmits and receives the radar signal having the carrier wave frequency of f₀₁ is defined as X₂₁;
the phase of the IF signal when the second radar transmits and receives the radar signal having the carrier wave frequency of f₀₂ is defined as X₂₂;
an error between the phase of X₁₁ and the phase of X₂₁ is defined as a phase error of Y₁;
an error between the phase of X₁₂ and the phase of X₂₂ is defined as a phase error of Y₂; and
the delay time calculation unit calculates the delay times based on the phase errors of Y₁ and Y₂ and the carrier wave frequencies of f₀₁ and f₀₂.

4. The radar system according to claim 1, wherein:
the radar signal includes a chirp signal whose frequency changes at a predetermined chirp rate; and
the delay time calculation unit calculates the delay times based on measurement results of the object using the radar signal having a plurality of mutually different chirp rates.

5. The radar system according to claim 4, wherein:
the plurality of radars include a first radar and a second radar;
the plurality of mutually different chirp rates includes two different chirp rates defined as μ₁ and μ₂;
the phase of the IF signal when the first radar transmits and receives the radar signal having the chirp rate of μ₁ is defined as X₁₁;
the phase of the IF signal when the first radar transmits and receives the radar signal having the chirp rate of μ₂ is defined as X₁₂;
the phase of the IF signal when the second radar transmits and receives the radar signal having the chirp rate of μ₁ is defined as X₂₁;
the phase of the IF signal when the second radar transmits and receives the radar signal having the chirp rate of μ₂ is defined as X₂₂;
an error between the phase of X₁₁ and the phase of X₂₁ is defined as a phase error of Y₁;
an error between the phase of X₁₂ and the phase of X₂₂ is defined as a phase error of Y₂;
frequencies of the IF signal corresponding to the chirp rates of μ₁ and μ₂ are defined as f_{b1} and f_{b2}, respectively; and
the delay time calculation unit calculates the delay times based on the phase errors of Y₁ and Y₂ and the frequencies of the IF signal of f_{b1} and f_{b2}.

6. The radar system according to claim 1, wherein:
the delay time calculation unit calculates the delay times based on measurement results of the object at a plurality of different distances.

7. The radar system according to claim 6, wherein:
the plurality of radars include a first radar and a second radar;
the plurality of different distances include two different distances defined as R₁ and R₂;
the phase of the IF signal when the first radar transmits and receives the radar signal to and from the object at the distance of R₁ is defined as X₁₁;
the phase of the IF signal when the first radar transmits and receives the radar signal to and from the object at the distance of R₂ is defined as X₁₂;
the phase of the IF signal when the second radar transmits and receives the radar signal to and from the object at the distance of R₁ is defined as X₂₁;
the phase of the IF signal when the second radar transmits and receives the radar signal to and from the object at the distance of R₂ is defined as X₂₂;
an error between the phase of X₁₁ and the phase of X₂₁ is defined as a phase error of Y₁;
an error between the phase of X₁₂ and the phase of X₂₂ is defined as a phase error of Y₂;
frequencies of the IF signal corresponding to the distances of R₁ and R₂ are defined as f_{b1} and f_{b2}, respectively; and
the delay time calculation unit calculates the delay times based on the phase errors of Y₁ and Y₂ and the frequencies of the IF signal of f_{b1} and f_{b2}.

8. The radar system according to claim 1, wherein:
the local oscillator is disposed in any one of the plurality of radars.

9. The radar system according to claim 1, wherein:
the local oscillator is disposed in a radar bridge connected to the plurality of radars.

10. The radar system according to claim 1, wherein:
the processor is disposed in any one of the plurality of radars.

11. The radar system according to claim 1, wherein:
the processor is disposed in a radar bridge connected to the plurality of radars.

12. The radar system according to claim 1, wherein:
a modulation method of the radar signal is linear frequency modulation, OFDM, or PMCW.

13. The radar system according to claim 1, wherein:
the radar system is mounted on a vehicle.
